(19) United States
(12) Patent Application Publication
(10) Pub. No.: US 2024/0202284 A1
(43) Pub. Date: Jun. 20, 2024

(54) SYSTEM AND METHOD FOR MONITORING AND IMPROVING CONVERSATIONAL ALIGNMENT TO DEVELOP AN ALLIANCE BETWEEN AN ARTIFICIAL INTELLIGENCE (AI) CHATBOT AND A USER

(71) Applicant: Wysa Inc, Boston, MA (US)

(72) Inventors: Jyotsana Vempati Aggarwal, Bengaluru (IN); Chaitali Sinha, Bengaluru (IN); Megha Gupta, Bengaluru (IN)

(21) Appl. No.: 18/082,388

(22) Filed: Dec. 15, 2022

Related U.S. Application Data
(60) Provisional application No. 63/290,045, filed on Dec. 15, 2021.

(51) Int. Cl. G06F 18/22; G06F 40/279; G06F 40/35; G06N 5/022

(52) U.S. Cl. CPC G06F 18/22; G06F 40/279; G06F 40/35; G06N 5/022

(57) ABSTRACT

A processor-implemented method for monitoring and improving conversational alignment to develop an alliance between an artificial intelligence (AI) chatbot and a user is provided. The method includes extracting sentiment or contextual features such as emotions, domains and medicalized terms from a response from the user and generating empathetic open-ended or closed-ended prompts based on them. Various AI models are used to determine if a conversation between the user and the AI chatbot has conversational alignment and a conversational alignment score is maintained which is updated after every message exchange. Recovery prompts are generated whenever a misalignment is detected in an attempt to bring the user back to the conversation. Appropriate prompts make the user feel heard and understood and enhance their trust in the AI chatbot. Once the conversational alignment score exceeds a threshold, alliance is assumed to be established and the user is offered an intervention.

### CROSS-REFERENCE TO RELATED APPLICATIONS

This patent application claims priority to pending U.S. provisional patent application No. 63/290,045 filed on Dec. 15, 2021, the complete disclosures of which, in their entirety, are hereby incorporated by reference.

### FIELD OF THE INVENTION

Embodiments of this disclosure generally relate to an artificial intelligence (AI) chatbot, and more particularly, to a system and method for monitoring and improving conversational alignment to develop an alliance between the artificial intelligence (AI) chatbot and a user.

### BACKGROUND

A chatbot is a computer program that simulates and processes human conversation to allow a human to interact with a digital device as if it were a real person. Conversational chatbots or digital assistants leverage natural-language understanding (NLU), natural language processing (NLP), and machine learning (ML) to understand and respond to a user's requests or queries, learn a user's preferences over time, provide recommendations, and even anticipate needs. Artificial intelligence chatbots are chatbots trained to have human-like conversations using a process known as natural language processing (NLP). With NLP, the AI chatbot can interpret human language as it is written, which enables it to carry on a conversation with the user without the need of any human intervention in normal course. Further, AI chatbot software can understand language outside of pre-programmed commands and provide a response based on existing data. This allows the users to lead the conversation, voicing their intent in their own words. However, if a demand is made that extends beyond the chatbot's capabilities, it might struggle.

Further, chatbots are typically not capable of empathizing with or emotionally relating to the user. Hence, it is difficult for a chatbot to build sufficient trust with a user for the user to open up and share their thoughts or feelings with the chatbot. For example, if the user feels low, upset, or frustrated, and expresses his/her feelings to the chatbot either directly or indirectly during the conversation, the chatbot may seem to lack empathy even if it correctly understands what the user is saying, because the chatbot may not be explicitly designed to give empathetic responses and a ‘lending ear’ to the user. The chatbot will move on with the conversation without showing any empathy, and even if its response is the ‘transactionally correct’ response, the lack of empathy could substantially reduce trust in the chatbot and its ability to help the user.

This can lead to the user feeling more frustrated, exiting the conversation, and/or being dissuaded from engaging with the chatbot in the future. On the other hand, if the chatbot is able to respond in a manner that indicates understanding and empathy, it will enhance trust. When there is trust, a user is more likely to engage with the chatbot, and even respond positively to suggestions or recommendations made by the chatbot. Hence, there remains a challenge for the chatbot to make the user feel heard and understood, and win the user's trust, which would encourage the user to respond positively to suggestions made by the chatbot. This also suggests the need for an ability of the chatbot to recover from any situations when the user's trust in it seems to have reduced.

### SUMMARY

In view of the foregoing, embodiments herein provide a processor-implemented method for monitoring and improving conversational alignment to develop an alliance between an artificial intelligence (AI) chatbot and a user. The method includes providing a first prompt to the user by the AI chatbot to obtain a first response from a user device associated with the user for the first prompt. The first response is at least one of a text input or a voice input. The method includes extracting sentiment or at least one contextual feature from the first response when the at least one contextual feature is present in the first response. Extracting the at least one contextual feature comprises detecting that the first response of the user includes at least one of emotion, medicalized terms or domain, wherein (i) the emotion is detected using an emotion detecting artificial intelligence (AI) model, (ii) the medicalized terms are detected using a medicalized term detecting AI model, and (iii) the domain is detected using a domain detecting AI model. The method includes generating a second prompt based on the at least one contextual feature includes at least one of the emotion, the medicalized terms or the domain. The method includes determining, using the AI model, if a conversation between the user and the AI chatbot has a conversational alignment. The conversational alignment is an alignment with respect to the user sharing more context with the AI chatbot and agreeing to suggestions or interpretations made by the AI chatbot. The method includes increasing a conversational alignment score for a second response of the user in the conversation if, using the AI model, the conversational alignment is determined. The method includes monitoring, using the AI model, the conversation to determine if there is a misalignment in the conversation between the user and the AI chatbot and reduce the conversational alignment score if the misalignment is detected. The method includes determining, using the AI model, a type of misalignment and generating a recovery prompt to recover from the misalignment. The method includes increasing the conversational alignment score for a third response from the user for the recovery prompt if the conversation is recovered from the misalignment and, using the AI model, the conversational alignment is determined for the third response. The method includes determining that the conversational alignment score exceeds a threshold by comparing the conversational alignment score with the threshold. The method includes generating an alliance confirmation prompt to confirm establishment of the alliance with the user when the conversational alignment score reaches the threshold.

In some embodiments, the method includes if a plurality of contextual features are detected in each response of the user, prioritizing the plurality of contextual features to decide which direction to take the conversation. The plurality of contextual features may be prioritized as (i) the at least one medicalized term, (ii) domain, and (iii) emotion

In some embodiments, prompts are generated based on a contextual feature that has highest priority among the plurality of contextual features, wherein the contextual feature that has the highest priority is identified by prioritizing the plurality of contextual features in a decreasing order.

In some embodiments, the method includes creating an intent for each type of misalignment for intent recognition by providing representative patterns for each type of misalignment. In some embodiments, the type of misalignment is determined using an intent recognition AI model. The type of misalignment may be selected from at least one of affirmation, confusion, disagreement, dissatisfaction, lack of trust, refusal, or uncertainty expressed by the user to the AI chatbot.

In some embodiments, at least one of the affirmation, the confusion, the disagreement, the dissatisfaction, the lack of trust, the refusal or uncertainty expressed by the user to the AI chatbot is detected using a classifier.

In some embodiments, the type of misalignment is classified using a plurality of machine learning models. In some embodiments, the plurality of machine learning models are trained based on training data that comprises examples of user text labeled as true, and the user text labeled as false.

In some embodiments, the method includes determining closest semantic and syntactic match for each response received from the user among all the representative patterns provided.

In some embodiments, if a confidence score for the matching pattern with a highest confidence score is above an intent matching threshold, a response received from the user is determined to correspond to the intent that the matching pattern represents.

In some embodiments, the recovery prompt is generated based on the type of misalignment determined.

In some embodiments, the conversational alignment score is updated after each response received from the user at the AI chatbot during the conversation and indicates strength of the conversational alignment formed between the AI chatbot and the user.

In some embodiments, the method includes vectorizing the text input received from the user to convert the user text into a numerical representation to use the numerical representation corresponding to the user text for training an AI model and for inferencing. In some embodiments, the text input is vectorized using frequency-based techniques or semantics-based techniques.

In some embodiments, the prompts are generated based on predefined base prompts that are written by conversation designers and parameterized with the user's context to personalize them. In some embodiments, the predefined base prompts are stored in a database of a server.

In some embodiments, the prompts are provided to the user through the AI chatbot until the conversational alignment score exceeds the threshold.

In some embodiments, at least one of the open-ended prompts or the closed-ended prompts are alternately provided to the user based on the conversational alignment score.

In some embodiments, the method includes recommending at least one intervention to the user when the alliance has been confirmed using the alliance confirmation prompt in which the user agrees to try out an intervention.

In one aspect, one or more non-transitory computer readable storage mediums storing one or more sequences of instructions, which when executed by one or more processors, causes a method for monitoring and improving conversational alignment to develop an alliance between an artificial intelligence (AI) chatbot and a user by performing the steps. The method includes providing a first prompt to the user by the AI chatbot to obtain a first response from a user device associated with the user for the first prompt. The first response is at least one of a text input or a voice input. The method includes extracting sentiment or at least one contextual feature from the first response when the at least one contextual feature is present in the first response. Extracting the at least one contextual feature comprises detecting that the first response of the user includes at least one of emotion, medicalized terms or domain, wherein (i) the emotion is detected using an emotion detecting artificial intelligence (AI) model, (ii) the medicalized terms are detected using a medicalized term detecting AI model, and (iii) the domain is detected using a domain detecting AI model. The method includes generating, using an AI model, a second prompt based on the at least one contextual feature includes at least one of the emotion, the medicalized terms or the domain. The method includes determining, using the AI model, if a conversation between the user and the AI chatbot has a conversational alignment. The conversational alignment is an alignment with respect to the user sharing more context with the AI chatbot and agreeing to suggestions or interpretations made by the AI chatbot. The method includes increasing, using the AI model, a conversational alignment score for a second response of the user in the conversation if the conversational alignment is determined. The method includes monitoring, using the AI model, the conversation to determine if there is a misalignment in the conversation between the user and the AI chatbot and reduce the conversational alignment score if the misalignment is detected. The method includes determining, using the AI model, a type of misalignment and generating a recovery prompt to recover from the misalignment. The method includes increasing, using the AI model, the conversational alignment score for a third response from the user for the recovery prompt if the conversation is recovered from the misalignment and the conversational alignment is determined for the third response. The method includes determining that the conversational alignment score exceeds a threshold by comparing the conversational alignment score with the threshold. The method includes generating an alliance confirmation prompt to confirm establishment of the alliance with the user when the conversational alignment score reaches the threshold.

In some embodiments, the method includes if a plurality of contextual features are detected in each response of the user, prioritizing the plurality of contextual features to decide which direction to take the conversation. The plurality of contextual features may be prioritized as (i) the at least one medicalized term, (ii) domain, and (iii) emotion

In some embodiments, prompts are generated based on a contextual feature that has highest priority among the plurality of contextual features, wherein the contextual feature that has the highest priority is identified by prioritizing the plurality of contextual features in a decreasing order.

In some embodiments, the method includes creating an intent for each type of misalignment for intent recognition by providing representative patterns for each type of misalignment. In some embodiments, the type of misalignment is determined using an intent recognition AI model. The type of misalignment may be selected from at least one of affirmation, confusion, disagreement, dissatisfaction, lack of trust, refusal or uncertainty expressed by the user to the AI chatbot.

In the second aspect, a system for monitoring and improving conversational alignment to develop an alliance between an artificial intelligence (AI) chatbot and a user is provided. The system includes a device processor and a non-transitory computer readable storage medium storing one or more sequences of instructions, which when executed by the device processor, causes a method by performing the steps. The method includes providing a first prompt to the user by the AI chatbot to obtain a first response from the user for the first prompt. The first response is at least one of a text input or a voice input. The method includes extracting sentiment or at least one contextual feature from the first response when the at least one contextual feature is present in the first response. Extracting the at least one contextual feature comprises detecting that the first response of the user includes at least one of emotion, medicalized terms or domain, wherein (i) the emotion is detected using an emotion detecting artificial intelligence (AI) model, (ii) the medicalized terms are detected using a medicalized term detecting AI model, and (iii) the domain is detected using a domain detecting AI model. The method includes generating, using an AI model, a second prompt based on the at least one contextual feature includes at least one of the emotion, the medicalized terms or the domain. The method includes determining, using the AI model, if a conversation between the user and the AI chatbot has a conversational alignment. The conversational alignment is an alignment with respect to the user sharing more context with the AI chatbot and agreeing to suggestions or interpretations made by the AI chatbot. The method includes increasing, using the AI model, a conversational alignment score for a second response of the user in the conversation if the conversational alignment is determined. The method includes monitoring, using the AI model, the conversation to determine if there is a misalignment in the conversation between the user and the AI chatbot and reduce the conversational alignment score if the misalignment is detected. The method includes determining, using the AI model, a type of misalignment and generating a recovery prompt to recover from the misalignment. The method includes increasing, using the AI model, the conversational alignment score for a third response from the user for the recovery prompt if the conversation is recovered from the misalignment and the conversational alignment is determined for the third response. The method includes determining that the conversational alignment score exceeds a threshold by comparing the conversational alignment score with the threshold. The method includes generating an alliance confirmation prompt to confirm establishment of the alliance with the user when the conversational alignment score reaches the threshold.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system that monitors and improves conversational alignment between an artificial intelligence (AI) chatbot and a user according to some embodiments herein;

FIG. 2 is a block diagram of a server of FIG. 1 according to some embodiments herein;

FIGS. 3A-3B are mock-up screenshots of user interfaces that illustrate a conversation between the AI chatbot and the user without misalignments according to some embodiments herein;

FIGS. 4A-4C are mock-up screenshots of user interfaces that illustrate a conversation between the AI chatbot and the user with one or more misalignments according to some embodiments herein;

FIG. 4D is an exemplary graphical representation of the conversational alignment score with the one or more misalignments according to some embodiments herein;

FIGS. 5A-5C are mock-up screenshots of user interfaces that illustrate a conversation between the user and the AI chatbot according to some embodiments herein;

FIG. 6 is a flowchart that illustrates a method for monitoring a conversational alignment and establishing an alliance between the artificial intelligence (AI) chatbot and the user by the server through the AI chatbot according to some embodiments herein;

FIG. 7 is a flow diagram that illustrates a method for monitoring and improving conversational alignment to develop an alliance between an artificial intelligence (AI) chatbot and a user according to some embodiments herein; and

FIG. 8 is a block diagram of a schematic diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

As used herein, the following terms and phrases shall have the meanings set forth below. Unless defined otherwise, all technical terms used herein have the same meaning as commonly understood to one of ordinary skill in the art. The singular forms “a”, “an”, and “the” include plural reference unless the context clearly dictates otherwise.

### Definitions

The term “open-ended prompt” is a question that cannot be answered with a “yes” or “no” response, or with one of a finite set of responses. Open-ended prompts are phrased as a statement which requires a longer response.

The term “closed-ended prompt” is a question that could potentially be answered with a “yes” or “no” response, or with one of a finite set of responses. However, they are phrased in such a way that the response could be a longer free text response as well.

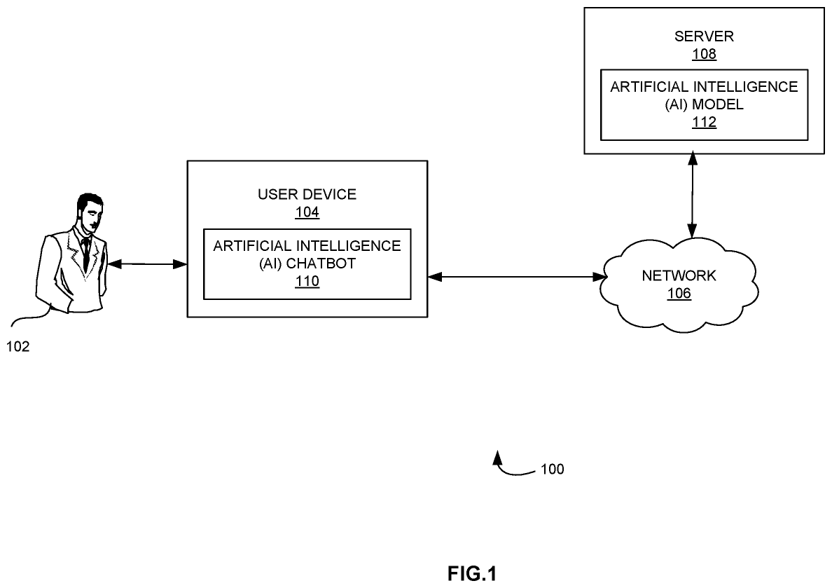

Referring now to the drawings, and more particularly to FIGS. 1 through 8, where similar reference characters denote corresponding features consistently throughout the figures, there are shown preferred embodiments.

FIG. 1 is a block diagram 100 that illustrates a system that monitors and improves a conversational alignment between an artificial intelligence (AI) chatbot 110 and a user 102 according to some embodiments herein. The block diagram 100 includes a user device 104 associated with the user 102, a network 106, and a server 108 that includes an artificial intelligence (AI) model 112. In some embodiments, the user device 104 includes the Artificial Intelligence (AI) chatbot 110. In some embodiments, the user device 104, without limitation, may be selected from a mobile phone, a Personal Digital Assistant (PDA), a tablet, a desktop computer, or a laptop.

The user device 104 may communicate with the server 108 through the network 106. In some embodiments, the network 106 is a wired network, a wireless network, or a combination of a wired network and a wireless network. In some embodiments, the network 106 is the Internet. The AI model 112 of the server 108 detects the sentiment (examples of sentiment types include positive, negative, and neutral) of a first response of the user 102. The first response is at least one of a text input or a voice input. In some embodiments, before training the AI model 112, the text input received from the user 102 is preprocessed that include steps such as spell correction, expansion of contractions, removal of stop words, stemming and lemmatization. The user text then needs to be vectorized so that the text is converted into a numerical representation which the AI model 112 can work with. In some embodiments, the text input is vectorized using frequency-based techniques such as Bag of Words (BoW), CountVectorizer, or TF-IDF, or semantics-based techniques such as word embeddings (eg., Word2Vec, GloVe, etc.). In some embodiments, pre-trained models from SpaCy, fastText, etc. can also be used for word embeddings. In some embodiments, the AI model 112 converts the first response or a second response received from the user 102 into the text input if the first response or the second response is the voice input using Natural Language Processing (NLP).

The AI chatbot 110 starts a conversation with the user 102 with an empathetic statement based on the sentiment of the user 102. As the user 102 responds to the empathetic statement and the conversation begins, the server 108 starts gathering context from the user 102. The AI model 112 dynamically generates prompts such as a first prompt, a second prompt, an alliance confirmation prompt, and a recovery prompt based on context gathered from the user 102. In some embodiments, the prompts are at least one of open-ended prompts or closed-ended prompts. In some embodiments, the context gathered from the user 102 includes extraction of one or more contextual features.

In some embodiments, the one or more contextual features are used to assist the chatbot 110 to understand and respond to the user 102. In some embodiments, the one or more contextual features that are extracted from a user response include suicidal thoughts, mentions of self-harm or abuse, emotions, domains (i.e., a topic of conversation), medicalized terms, entities, agreement with the chatbot 110, dissatisfaction or disagreement with the chatbot 110, uncertainty, sentiment, confusion, and lack of trust in the AI chatbot 110. In some embodiments, if a contextual feature is not extracted from the user message, the AI model 112 automatically provides at least one of an open-ended prompt or a closed-ended prompt to obtain more context from the user 102. In some embodiments, if only one of the contextual features is identified in the user message, the AI model 112 may generate at least one of the open-ended or the closed-ended prompt based on that one contextual feature. In some embodiments, if the one or more contextual features are identified in the gathered context, the AI model 112 prioritizes the one or more contextual features based on an importance of the one or more features. The AI model 112 may generate at least one of the open-ended or the closed-ended prompt based on the most important contextual feature identified in the user text. In some embodiments, the contextual features are prioritized in decreasing order of importance as suicidal thoughts, mentions of self-harm or abuse, confusion, dissatisfaction, lack of trust or disagreement with the AI chatbot 110, uncertainty, medicalized terms, domains, emotions, agreement with the AI chatbot 110, and sentiment.

In some embodiments, the AI model 112 provides at least one of the open-ended or closed-ended prompts to the user 102 through the AI chatbot 110 to gather more context from the user 102. In some embodiments, the AI model 112 provides at least one of the open-ended or closed-ended prompts to the user 102 through the AI chatbot 110 until an alliance is confirmed to be established between the user 102 and the AI chatbot 110. In some embodiments, the AI chatbot 110 may not wait for the alliance to be established before recommending a solution to the user 102 if the user message indicates an urgent need that must be immediately addressed.

In some embodiments, the server 108 includes one or more AI models to detect and extract one or more relevant conversational features of the user text. The one or more relevant features correspond to any aspect of the user message that are used to assist the AI chatbot 110 to understand and respond to the user 102 better so that the user 102 feels heard and understood. In some embodiments, detection of the one or more relevant conversational features include detection of whether the user 102 is agreeing (e.g., “Yes, that's right.”) or disagreeing with the chatbot 110 (e.g., “I don't think so”), whether the user 102 is in distress and might need immediate help (e.g., “I'm having a panic attack”), confused (e.g., “What do you mean?”), unhappy with the chatbot 110 (e.g., “You're not even helping!”), uncertain about how to respond (e.g., “Umm . . . I don't really know”), lacking trust in the AI chatbot 110 (e.g., “I don't think you can help me”), etc. In addition, the AI model 112 extracts one or more contextual features that are used to assist the chatbot 110 to respond to the user 102 better. The contextual features may include a domain, e.g., what the user 102 is talking about (relationship, education, health, money, politics, sports, etc.); entity, e.g., who the user 102 is talking about (self, family member, coworker, friend, etc.); sentiment, i.e., whether the tone of the user 102's message is positive, negative or neutral; emotion, e.g., how the user 102 is feeling (sad, angry, happy, frustrated, scared, etc.); among other things the user 102 might mention (activities, medicalized terms, events, etc.).

The AI models may be trained on training data obtained from multiple sources, such as user messages from conversations in the past with any Personal Identifiable Information (PII) replaced by synthetic data, manually created examples (i.e., synthetic statements manually created by data scientists based on the expected response of the user 102), third-party public datasets, e.g., Kaggle, and Web scraping, e.g., from Reddit, Twitter by Twitter, Inc, news websites, etc.

In some embodiments, the open-ended prompts or the closed-ended prompts are generated based on predefined base prompts written by conversation designers. These base prompts are parameterized with the user's context to personalize them. For example, an open-ended prompt could comprise a context-based empathetic statement followed by a predefined base prompt like. “How did (context) make you feel?”. Thus, if the user 102 talks about a conflict with a colleague, the open-ended prompt would comprise an empathetic statement based on this context like “I understand things are not going well with your colleague at the moment.”, followed by the contextualized base prompt like “How did this conflict make you feel?”. In some embodiments, the predefined base prompts are stored in the server 108. In some embodiments, the open-ended prompts or the closed-ended prompts are provided alternately to the user 102 based on a conversational alignment score.

The AI model 112 continuously monitors the conversation between the user 102 and the AI chatbot 110 to determine if the conversation between the user 102 and the AI chatbot 110 has conversational alignment. The conversational alignment is an alignment with respect to the user 102 sharing more context or agreeing with the AI chatbot 110 when prompted by the AI chatbot 110. For example, if the AI chatbot 110 provides the open-ended prompt, (e.g., “What bothered you the most about this situation?”) or the closed-ended prompt (e.g., “Do you sometimes wish that you had more control over how others act?”), the user 102 may share more (e.g., “That I am not considered important by my family”) or agree with the chatbot 110 (e.g., “Yes, I think so.”), thus indicating conversational alignment. In some embodiments, the AI model 112 determines a misalignment by the user's confusion, (e.g., “What do you mean by that?”), dissatisfaction (e.g., “You don't understand me!”), disagreement (e.g., “No, that's not what I meant”), lack of trust (e.g., “A bot can't help me”), or uncertainty (e.g., “I'm not sure”).

The AI model 112 maintains the conversational alignment score, which indicates the strength of the alliance formed between the AI chatbot 110 and the user 102. The conversational alignment score is updated after each message exchange based on the conversation of the user 102 with the AI chatbot 110. For example, the conversational alignment score is increased in case of the conversational alignment, i.e., if the user 102 goes with the flow, responds to the AI chatbot 110 promptly by sharing more, or agrees with the AI chatbot 110. The conversational alignment score is decreased when the AI model 112 detects a lack of conversational alignment, i.e., when the user 102 doesn't agree with the AI chatbot 110, is confused, dissatisfied, or unsure about how to respond to the AI chatbot 110.

If the conversation between the user 102 and the AI chatbot 110 is not aligned, the server 108 reduces the conversational alignment score and attempts to recover from this setback by addressing the user's concerns empathetically and bringing the user 102 back to the conversation. For example, if the AI chatbot 110 provides the open-ended prompt, e.g., “How did that make you feel?” and the user 102 expresses uncertainty, e.g., “I don't really know . . . can't say . . . ”, the AI chatbot 110 will respond empathetically, e.g., “That's also okay. Sometimes our feelings go into hiding for a bit.” and bring the user 102 back to the conversation, e.g., “Do you think there is anything in this situation that you can change?”. Another example could be when the user 102 expresses dissatisfaction, e. g., “I don't think you can help me”, the AI chatbot 110 may respond to the user 102, e.g., “I'm trying my best to understand you better. Try venting to me, it will help.”.

The AI model 112 continuously monitors the conversational alignment score and compares the conversational alignment score to a threshold after every message exchange and score update. In some embodiments, the threshold for the conversational alignment score is determined based on data analysis to determine which value results in best performance over a validation dataset. When the conversational alignment score exceeds the threshold, the server 108 dynamically provides an alliance confirmation prompt to the user 102 to confirm the establishment of the alliance and checks if the user 102 is now ready to accept an intervention, e.g., “Thanks for sharing that with me. I have something that could help you manage this better. Would you like to try it out?”. In some embodiments, when the alliance is established, the alliance may be similar to a therapeutic alliance between a human therapist and the user 102. In some embodiments, when the alliance is established and confirmed by the user 102, the AI chatbot 110 may recommend some interventions or solutions to the user 102. In some embodiments, a recommended activity is a therapeutic intervention, e.g., a breathing exercise, a physical activity, writing down and reframing thoughts, etc.

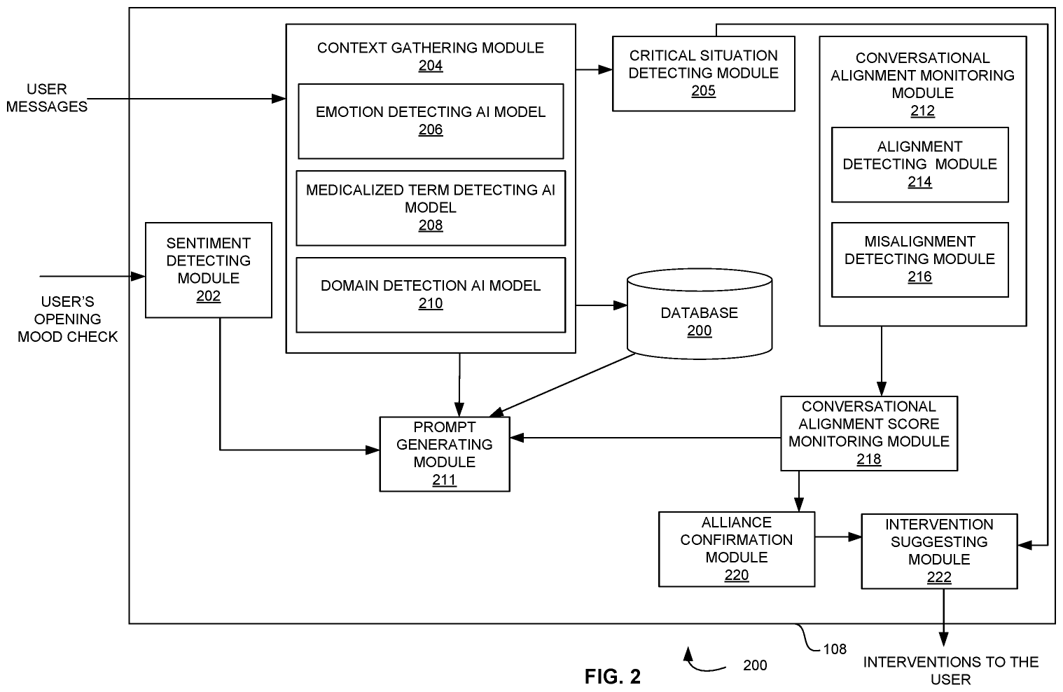

FIG. 2 is a block diagram 200 of the server 108 of FIG. 1 according to some embodiments herein. The server 108 includes a database 200, a sentiment detecting module 202, a context gathering module 204, a critical situation detecting module 205, a prompt generating module 211, a conversational alignment monitoring module 212, a conversational alignment score monitoring module 218, an alliance confirmation module 220, and an intervention suggesting module 222. The context gathering module 204 includes an emotion detecting AI model 206, a medicalized term detecting AI model 208, and a domain detecting AI model 210. The conversational alignment monitoring module 212 includes an alignment detecting module 214 and a misalignment detecting module 216. The sentiment detecting module 202 sentiment detects sentiment (positive, negative, or neutral) of the user's opening text and starts a conversation with the user 102 with an empathetic statement based on the sentiment of the user 102.

The context gathering module 204 extracts one or more contextual features from the user text. In some embodiments, contextual features are extracted using the emotion detecting AI model 206, the medicalized term detecting AI model 208, and the domain detecting AI model 210. In some embodiments, the emotion detecting AI model 206 detects emotion words such as “anxious”, “scared”, and “restless” expressed by the user 102 to direct the conversation accordingly. In some embodiments, the medicalized term detecting AI model 208 detects medicalized terms such as panic attack, depression, and diabetes in the user text.

In some embodiments, if the medicalized term detecting AI model 208 detects one or more medicalized terms, the medicalized term detecting AI model 208 then checks if the user 102 is mentioning those terms with respect to themselves, and if the user 102 is in distress and needs immediate help. The domain detecting AI model 210 extracts a topic of the conversation such as relationships, work, education, and abuse from the user text. In some embodiments, if multiple contextual features (e.g., emotions, domains, medicalized terms) are detected in the context gathered from the user 102, they are prioritized in the following order to decide which direction to take the conversation in: (i) medicalized terms, (ii) domain, and (iii) emotion. In some embodiments, the relevant pieces of contextual information extracted from the user's texts are stored in the database 200 of the server 108. For example, if the medicalized term is detected, the open-ended prompt, e.g., “What does a professional have to say about this?” or “What's the hardest part about {detected_medicalized_term}?” is provided to the user 102. Similarly, if the domain is detected, the open-ended prompt, e.g., “What's the hardest part about that?” is given, and in case of the detected emotion, a prompt, e.g., “Tell me more about this feeling.” is given to the user 102.

The prompt generating module 211 dynamically generates at least one of open-ended or closed-ended prompts based on relevant pieces of the one or more contextual features extracted from the user's texts to make the user 102 feel heard and understood, and to obtain further context from the user 102.

In some embodiments, the open-ended prompts or the closed-ended prompts are customized in such a way that the open-ended prompts or the closed-ended prompts are specific to a type of context detected to fit a variety of situations. In some embodiments, the open-ended prompts or the closed-ended prompts are generated by the prompt generating module 211 based on predefined base prompts that are written by conversation designers. These base prompts are parameterized with the user's context to personalize them. For example, a predefined base prompt may be “(empathetic statement based on context). How did (context) make you feel?”. If the user 102 talks about conflict with a colleague, the predefined base prompt will be personalized like “I understand things are not going well with your colleague at the moment. How did this conflict make you feel?” In some embodiments, the predefined base prompts are enabled to ensure that generated prompts are safe and do not trigger the user 102 by inadvertently saying something inappropriate.

In some embodiments, the prompt generating module 211 offers an empathetic statement followed by at least one of open-ended or closed-ended prompts to the user 102 based on the extracted context. For example, if a medicalized term such as ‘depression’ is detected, an empathetic open-ended prompt such as “That can feel like an exhausting battle within. What's the most difficult part about depression?” is given to the user 102. Similarly, if a domain like ‘education failure’ is detected, an empathetic open-ended prompt such as “That sounds hard. While success gives us energy, failure helps us grow. Both are a part of making you the awesome person you are. I'm certain you will bounce back no matter what happens. As challenging as this is, what would you say is the most difficult part of it for you right now?” is given, and in case of a detected emotion like ‘sadness’, an empathetic open-ended prompt like “I understand you're feeling sad. It's only natural to feel this way. Tell me more about this feeling.” is shown.

In some embodiments, the prompt generating module 211 offers prompts in such a way that while they are specific to a type of context detected, they are still generic enough to fit a variety of situations. For example, a generic open-ended prompt designed for the “fear” emotion could be “Breathe deeply. Everything that you need to cope with your fear is within you. Tell me more about this feeling.” While this prompt is tailored to a specific emotion, it is generic enough to fit any situation where the user might be feeling scared. In some embodiments, if no contextual feature is extracted from the user text, a generic open-ended or closed-ended prompt like “I hear you. What's the hardest part about that?” is offered which fits a variety of situations even though the exact context is unknown.

In some embodiments, based on the user's response to the open-ended prompt and the further context derived from it, if any, the prompt generating module 211 offers a follow-up closed-ended question like “Is there something that has been already helping you cope?”, “Are there some things in your control that you can change?”, or “Do you often struggle with this feeling?” through the AI chatbot 110.

The conversational alignment monitoring module 212 continuously monitors the conversation between the user 102 and the AI chatbot 110 to determine if the user's response is aligned with the AI chatbot's 110 message or not. In some embodiments, this monitoring includes checking for alignment, i.e., whether the user 102 shared any more context or agreed with the AI chatbot 110 and misalignment, i.e., whether the user 102 expressed confusion, disagreement, dissatisfaction or uncertainty. The conversational alignment monitoring module 212 maintains a conversational alignment score for the conversation and updates the conversational alignment score based on whether the conversational alignment between the user 102 and the AI chatbot 110 is identified or not after every message exchange.

If the alignment detecting module 214 detects that the conversation between the user 102 and the AI chatbot 110 is aligned (e.g., the user 102 shared more context when prompted by the AI chatbot 110, or agreed with the AI chatbot 110), the conversational alignment score is increased. For example, the alignment detecting module 214 may increase the conversational alignment score if the AI chatbot 110 asks “What's bothering you?” and the user 102 responds with “I had a fight with my mom.” since the user 102 shared more when prompted by the AI chatbot 110.

If the misalignment detecting module 216 detects that there is misalignment in the conversation between the user 102 and the AI chatbot 110 (e.g., the user 102 expressed confusion, disagreement, dissatisfaction or uncertainty when prompted by the AI chatbot 110), the conversational alignment score is decreased. The misalignment detecting module 216 determines a type of misalignment and generates a recovery prompt to recover from the misalignment. In some embodiments, the recovery prompt is generated based on the type of misalignment determined.

In some embodiments, the misalignment detecting module 216 creates an intent for each type of misalignment for intent recognition by providing representative patterns for each type of misalignment. The type of misalignment may be determined using an intent recognition AI model. The type of misalignment may be selected from at least one of confusion, disagreement, dissatisfaction, lack of trust, refusal or uncertainty expressed by the user 102 to the AI chatbot 110.

For example, the misalignment is detected if the user 102 may be confused as to what the AI chatbot 110 is saying or asking them, e.g., “What do you mean by that?”, “Can you explain?”, “I didn't get you”, “Come again?” and “I don't understand”. The misalignment is detected if the user 102 may disagree with what the AI chatbot 110 said, e.g., “No, that's not what I meant”, “Not really”, “That's not true”, “I don't think so”, etc. The misalignment is detected if the user 102 may be unsure about how to respond to the AI chatbot 110, e.g., “I'm not sure”, “I don't really know”, “Umm . . . can't say”, “Dunno”, “Idk”, etc. The misalignment is detected if the user 102 may be dissatisfied or unhappy with what the AI chatbot 110 is asking them or how the AI chatbot 110 is responding to them, e.g., “You don't understand me!”, “Are you even listening?”, “You're just a stupid ai”, “I don't want to do this”, “I already told you this”, “Stop repeating yourself”, “You don't really understand what I'm saying, do you?”, etc.

The misalignment is detected if the user 102 may not trust the AI chatbot 110 enough, e.g., “You can't help me”, “You wouldn't understand”, “You are just a bot. How can you help me?”, “I don't think you can make me feel any better”, etc. The misalignment is detected if the user 102 may refuse to do what the AI chatbot 110 suggests them to do, e.g., “I don't want to”, “I can't”, “Not really”, “No, can we do something else?”, etc.

In some embodiments, the closest semantic and syntactic match among all the representative patterns provided for each intent is determined for each response received from the user 102. In some embodiments, if the confidence score for the matching pattern with a highest confidence score is above an intent matching threshold, a response received from the user 102 is determined to correspond to the intent that the matching pattern represents. For example, if the user text “Can you even understand me?” finds the best match in the pattern “You don't understand me!” with a confidence score higher than the intent matching threshold, then the user text can be detected as a misalignment of the dissatisfaction type because the matching pattern belongs to that intent.

In some embodiments, if the misalignment detecting module 216 detects a misalignment, the conversational alignment score is reduced. For example, the misalignment detecting module 216 may reduce the conversational alignment score if the AI chatbot 110 asks “What's bothering you?” and the user 102 expresses uncertainty by responding with “I don't really know”.

When the misalignment detecting module 216 detects a decrease in alliance (the user 102 expresses confusion, disagreement, dissatisfaction or uncertainty when prompted by the AI chatbot 110), the prompt generating module 211 attempts to recover from this setback by addressing the user's concerns empathetically and bringing the user 102 back to the conversation. For example, if the AI chatbot 110 offered an open-ended prompt like “How did that make you feel?” and the user 102 expresses lack of trust or dissatisfaction by saying “You're just a bot. You can't help me.”, the AI chatbot 110 may try to recover from this decrease in alliance by responding with “I'm trying my best to understand you better. Try venting to me, it will help.”.

The conversational alignment score monitoring module 218 continuously monitors the conversational alignment score to determine if the conversational alignment score exceeds a threshold and determines if the user 102 feels heard and understood by the AI chatbot 110 and is ready to accept an intervention or a recommendation. The intervention suggesting module 222 checks the user's readiness to use an intervention. At this point, the alliance confirmation module 220 dynamically provides an alliance confirmation prompt that is generated by the prompt generating module 211 to confirm the establishment of the alliance with the user 102 when the conversational alignment score exceeds the threshold. This closed-ended prompt could look like “I may have something to help you manage your feelings around this. Would you like to give it a try?” If the user 102 accepts this “handshake”, the alliance is confirmed to have been formed.

In some embodiments, if the context gathering module 204 detects that the user 102 is in distress and needs immediate help, the critical situation detection module 205 takes over and immediately offers a suitable intervention to the user 102 based on the context gathered without waiting for an alliance to be formed through a conversational alliance scoring mechanism.

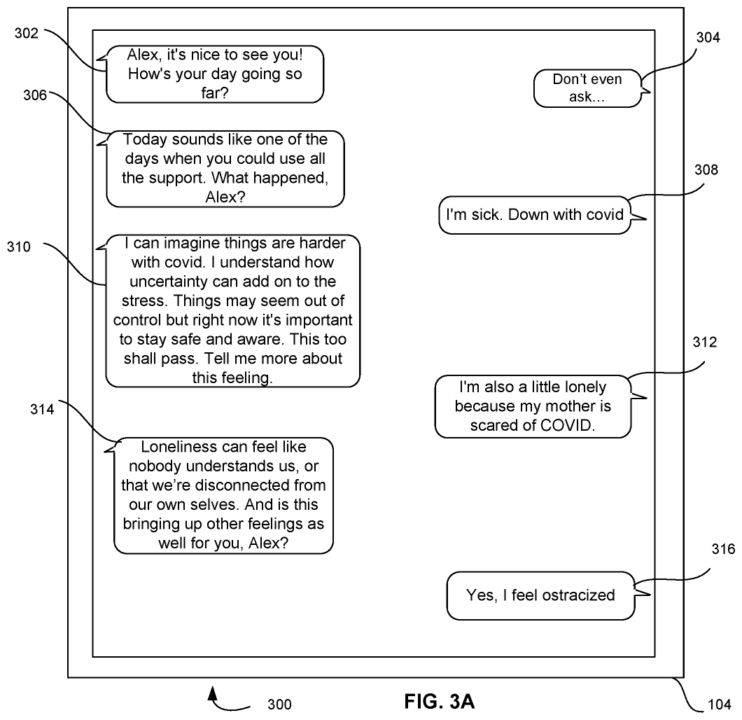

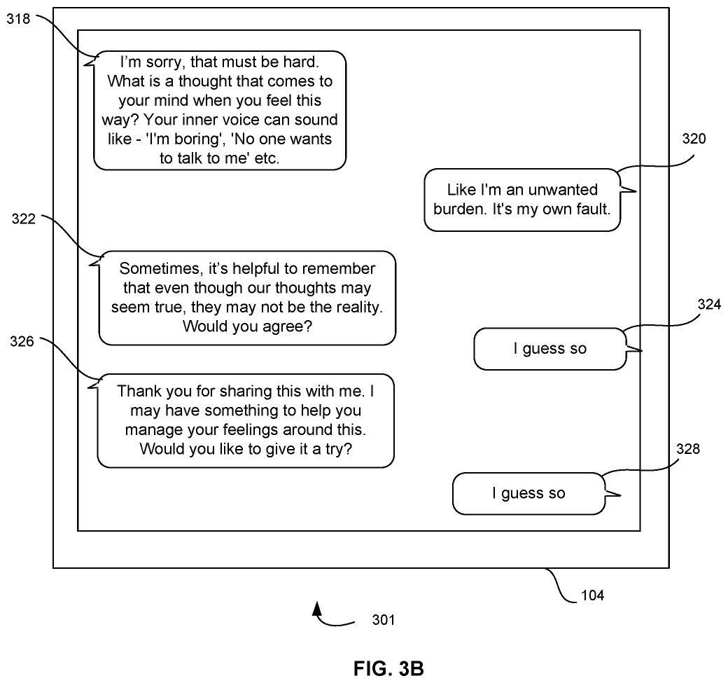

In some embodiments, the AI chatbot 110 is a digital assistant for mental health. FIGS. 3A-3B are mock-up screenshots of user interfaces that illustrate a conversation between the AI chatbot 110 and the user 102 without misalignments according to some embodiments herein. In FIG. 3A of a user interface 300, the AI chatbot 110 starts a conversation with the user 102 with an empathetic statement 302, e.g., “Alex, it's nice to see you! How's your day going so far?”. The user 102 may respond with 304 to the empathetic statement 302 provided by the AI chatbot 110, e.g., “Don't even ask.” The sentiment detecting module 202 detects sentiment of the user's response 304. Based on the sentiment detected by the sentiment detecting module 202 (negative in this case), the prompt generating module 211 provides an open-ended prompt 306, e.g., “Today sounds like one of the days when you could use all the support. What happened, Alex?” to the user 102. The user 102 may respond with 308 to the open-ended prompt 306, e.g., “I'm sick. Down with covid”. The emotion detecting AI model 206 detects emotion, e.g., ‘unwell’ of the user 102 and the medicalized term detecting AI model 208 detects a medicalized term, e.g., ‘covid’. The conversational alignment monitoring module 212 of the AI model 112 increases the conversational alignment score for this conversation by 5 as the user 102 shared some context with the AI chatbot 110.

The prompt generating module 211 provides an empathetic open-ended prompt 310 to the user 102 through the AI chatbot 110 based on the medicalized term, e.g., “I can imagine things are harder with covid. I understand how uncertainty can add on to the stress. Things may seem out of control but right now it's important to stay safe and aware. This too shall pass. Tell me more about this feeling”. The user 102 may respond with 312 to the open-ended prompt 310 provided by the AI chatbot 110, e.g., “I'm also a little lonely because my mother is scared of COVID.” The emotion detecting AI model 206 detects the emotion, e.g., “lonely” of the user 102. The conversational alignment monitoring module 212 increases the conversational alignment score by 5 to a total of 10 because the user shared further context.

The prompt generating module 211 generates and provides an empathetic closed-ended prompt 314 to the user 102 through the AI chatbot 110 based on the emotion of the user 102, e.g., “Loneliness can feel like nobody understands us, or that we're disconnected from our own selves. And is this bringing up other feelings as well for you, Alex?” The user 102 may respond with 316 to the closed-ended prompt 314 provided by the AI chatbot 110, e.g., “Yes, I feel ostracized.” The conversational alignment monitoring module 212 of the AI model 112 increases the conversational alignment score by 5 to 15 because the user 102 shared more when prompted.

In FIG. 3B of a user interface 301, the prompt generating module 211 provides an open-ended prompt 318 to the user 102 through the AI chatbot 110 regarding negative feelings of the user 102, e.g., “I'm sorry, that must be hard. What is a thought that comes to your mind when you feel this way? Your inner voice can sound like—‘I'm boring’, ‘No one wants to talk to me’, etc”. The user 102 may respond with 320 to the open-ended prompt 318 provided by the AI chatbot 110, e.g., “Like I'm an unwanted burden. It's my own fault”. The conversational alignment monitoring module 212 updates the conversational alignment score for this user to 20.

The prompt generating module 211 generates and provides an empathetic closed-ended prompt 322 to the user 102 through the AI chatbot 110, e.g., “Sometimes, it's helpful to remember that even though our thoughts may seem true, they may not be the reality. Would you agree?” The user 102 may respond with 324 to the closed-ended prompt 322 provided by the AI chatbot 110, e.g., “I guess so.” The conversational alignment monitoring module 212 of the AI model 112 increases the conversational alignment score to 25 because the user 102 agreed with the AI chatbot 110. The conversational alignment score monitoring module 218 determines that the conversational alignment score, (e.g. 25) has reached a threshold of the conversational alignment score (25 in this case).

The alliance confirmation module 220 checks the user's readiness to use an intervention when the conversational alignment score exceeds the threshold by dynamically providing an alliance confirmation prompt 326 to the user 102, e.g., “Thank you for sharing this with me. I may have something to help you manage your feelings around this. Would you like to give it a try?” The user 102 may accept the intervention by responding with 328 to the alliance confirmation prompt 326 provided by the AI chatbot 110, e.g., “Yes, let's try.”

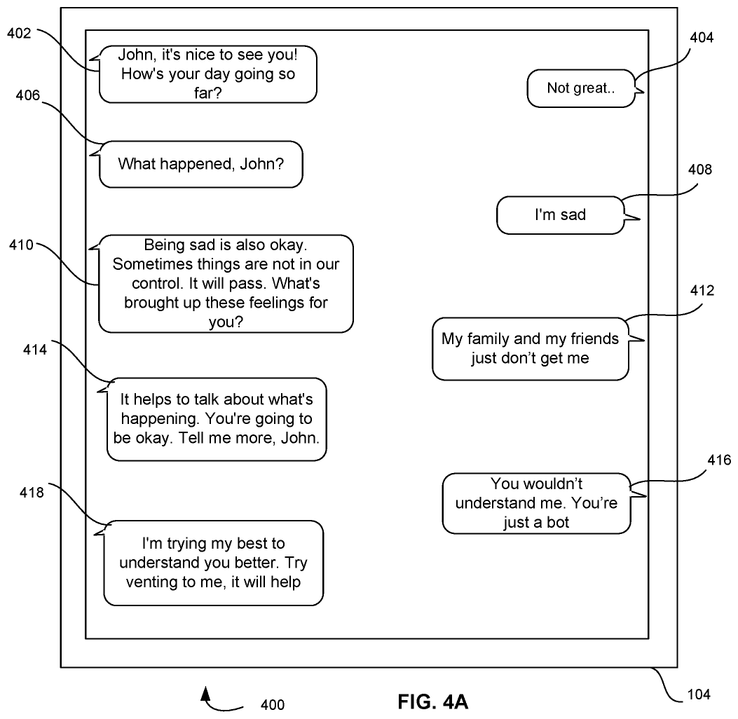

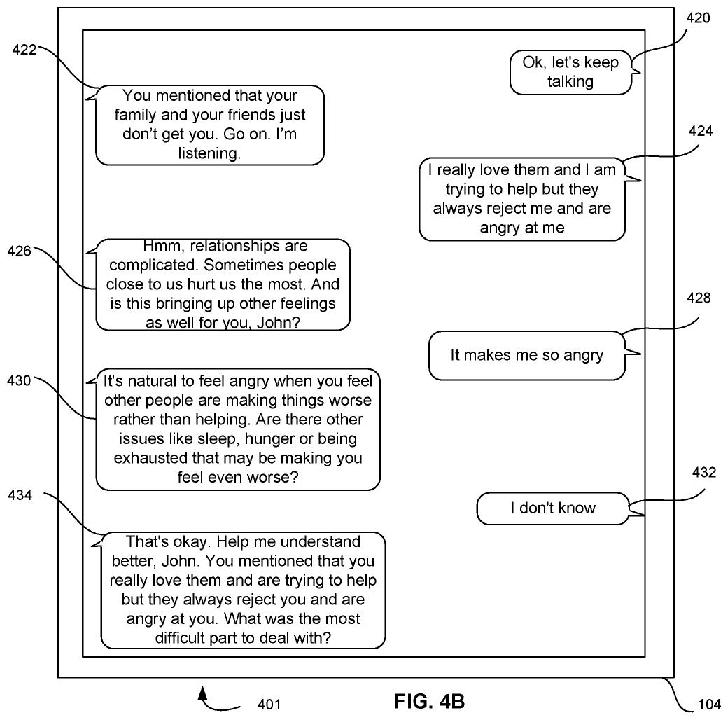

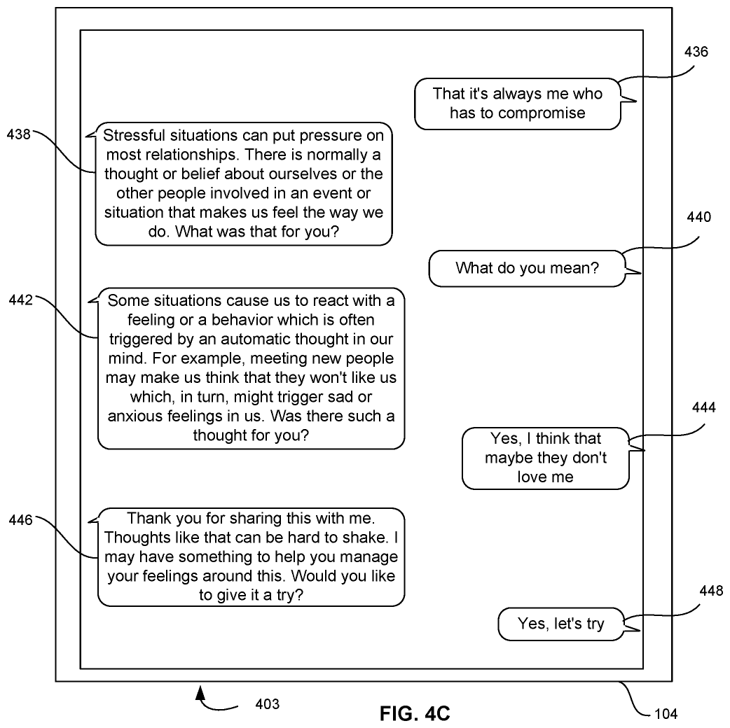

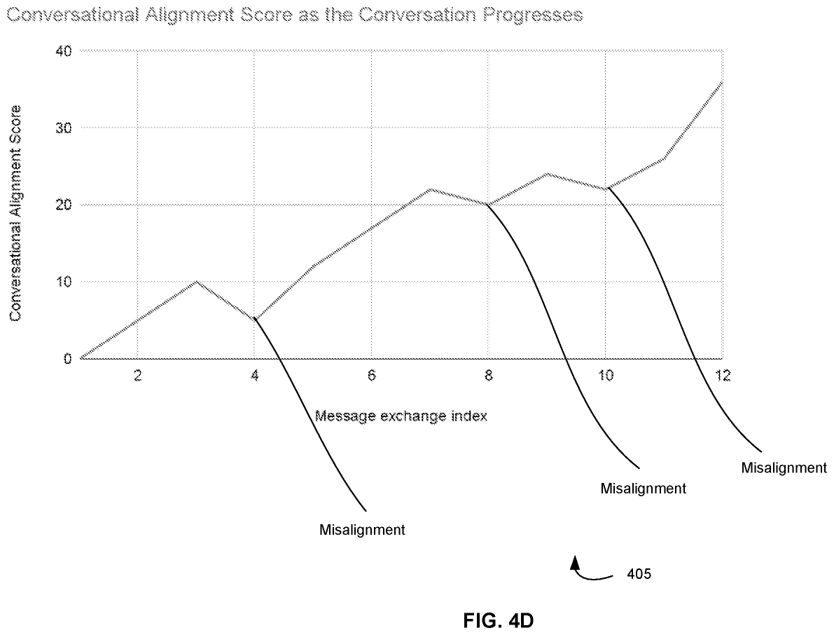

FIGS. 4A-4C are mock-up screenshots of user interfaces that illustrate a conversation between the AI chatbot 110 and the user 102 with one or more misalignments according to some embodiments herein. In FIG. 4A of a user interface 400, the AI chatbot 110 starts a conversation with the user 102 with a mood check 402, e.g., “John, it's nice to see you! How's your day going so far?”. The user 102 may respond with 404 to the AI chatbot 110, e.g., “Not great.” The sentiment detecting AI model 202 detects that the response 404 provided by the user 102 has a negative sentiment. Based on the sentiment detected, the AI chatbot 110 provides an open-ended prompt 406, e.g., “What happened, John?” to the user 102. The user 102 may respond with 408 to the open-ended prompt 406, e.g., “I'm sad”. The emotion detecting AI model 206 detects the emotion, e.g., “sad” of the user 102 from the response 408 received from the user 102. The conversational alignment monitoring module 212 of the AI model 112 assigns the starting conversational alignment score as 5 because the user 102 shared some context.

The prompt generating module 211 provides an empathetic open-ended prompt 410 to the user 102 through the AI chatbot 110 based on the emotion, e.g., “Being sad is also okay. Sometimes things are not in our control. It will pass. What brought up these feelings for you?”. The user 102 may respond with 412 to the open-ended prompt 410 provided by the AI chatbot 110, e.g., “My family and my friends just don't get me.” The domain detecting AI model 210 detects context, e.g., relationship of the user 102 in the response 412 received from the user 102. The conversational alignment monitoring module 212 increases the conversational alignment score to 10 as the user 102 shares further context when prompted by the chatbot 110.

The prompt generating module 211 provides an empathetic closed-ended prompt 414 to the user 102 through the AI chatbot 110 based on the detected domain, e.g., “It helps to talk about what's happening. You're going to be okay. Tell me more, John”. The user 102 may respond with 416 to the closed-ended prompt 414 provided by the AI chatbot 110, e.g., “You wouldn't understand me. You're just a bot.” The misalignment detecting module 214 detects that there is misalignment in the conversation of the user 102 as the user 102 refused to share and showed a lack of trust in the AI chatbot 110. Hence, the conversational alignment score is reduced to 5 for this major misalignment.

The conversation alignment score monitoring module 218 detects a drop in the conversational alignment between the user 102 and the AI chatbot 110 and attempts to recover from this misalignment and bring back the user 102 to the conversation by providing a recovery prompt 418 to the user 102 through the prompt generating module 211, e.g., “I'm trying my best to understand you better. Try venting to me, it will help.”

In FIG. 4B of a user interface 401, the user 102 may respond with 420 to the recovery prompt 418 provided by the AI chatbot 110, e.g., “Ok, let's keep talking.” The AI chatbot 110 recovered from the major misalignment as the user 102 agreed to continue with the conversation. Thus, the conversational alignment monitoring module 212 rewards this recovery by increasing the conversational alignment score to 12.

To bring the user 102 back to the conversation, the prompt generating module 211 generates an open-ended prompt 422 by replaying the response 412 shared by the user 102 before the misalignment was detected. The prompt generating module 211 provides the open-ended prompt 422 to the user 102 through the AI chatbot 110, e.g., “Okay, you mentioned that your family and your friends just don't get you. Go on. I'm listening.” The user 102 may respond with 424 to the open-ended prompt 422 provided by the AI chatbot 110, e.g., “I really love them and I am trying to help but they always reject me and are angry at me.” The domain detecting AI model 210 detects the context, e.g., relationship of the user 102 in the response 424. The conversational alignment monitoring module 212 increases the conversational alignment score for this user shared context to 17.

The prompt generating module 211 generates and provides an empathetic closed-ended prompt 426 regarding the detected domain to the user 102 through the AI chatbot 110, e.g., “Hmm, relationships are complicated. Sometimes people close to us hurt us the most. And is this bringing up other feelings as well for you, John?” The user 102 may respond with 428 to the closed-ended prompt 426 provided by the AI chatbot 110, e.g., “It makes me so angry.” The conversational alignment monitoring module 212 increases the conversational alignment score for this user shared context to 22.

Further, the prompt generating module 211 generates and provides an empathetic closed-ended prompt 430 to the user 102 through the AI chatbot 110 based on the emotion detected in the response 428 of the user 102, e.g., “It's natural to feel angry when you feel other people are making things worse rather than helping. Are there other issues like sleep, hunger or being exhausted that may be making you feel even worse?” The user 102 may respond with 432 to the closed-ended prompt 430 provided by the AI chatbot 110, e.g., “I don't know.” The misalignment detecting module 214 detects that there is a misalignment in the conversation of the user 102 as the user 102 expressed uncertainty about how to respond to the AI chatbot 110. The conversational alignment monitoring module 212 reduces the conversational alignment score to 20 for this minor misalignment.

The prompt generating module 211 generates an open-ended prompt 434 based on the response 424 shared by the user 102 for the open-ended prompt 422, i.e., by replaying the response 424 shared by the user 102 before the misalignment was detected. The prompt generating module 211 provides the open-ended prompt 434 to the user 102 through the AI chatbot 110, e.g., “That's okay. Help me understand better, John. You mentioned that you really love them and are trying to help but they always reject you and are angry at you. What was the most difficult part to deal with?”

In FIG. 4C of a user interface 403, the user 102 may respond with 436 to the open-ended prompt 434 provided by the AI chatbot 110, e.g., “That it's always me who has to compromise.” The conversational alignment monitoring module 212 rewards this recovery from the minor misalignment by increasing the conversational alignment score to 24.

The prompt generating module 211 generates and provides an open-ended prompt 438 to the user 102 through the AI chatbot 110 based on the context detected earlier, i.e., the relationship domain detected in the response 424 of the user 102, e.g., “Stressful situations can put pressure on most relationships. There is normally a thought or belief about ourselves or the other people involved in an event or situation that makes us feel the way we do. What was that for you?” The user 102 may respond with 440 expressing confusion to the open-ended prompt 438 provided by the AI chatbot 110, e.g., “What do you mean?” The misalignment detecting module 214 detects that there is a misalignment in the conversation of the user 102 as the user 102 didn't understand what the AI chatbot 110 was saying or asking. The conversational alignment monitoring module 212 reduces the conversational alignment score to 22 for this minor misalignment.

The AI model 112 recovers from this misalignment and brings back the user 102 to the conversation by providing an explanation and a recovery prompt 442 to the user 102 through the AI chatbot 110, e.g., “Some situations cause us to react with a feeling or a behavior which is often triggered by an automatic thought in our mind. For example, meeting new people may make us think that they won't like us which, in turn, might trigger sad or anxious feelings in us. Was there such a thought for you?”

The user 102 may respond with 444 to the recovery prompt 442 provided by the AI chatbot 110, e.g., “Yes, I think that maybe they don't love me.” Since the AI chatbot 110 succeeded in getting the user 102 to share more, the conversational alignment monitoring module 212 rewards this recovery from a minor misalignment by increasing the conversational alignment score to 26.

The conversational alignment score monitoring module 218 detects that the conversational alignment score has exceeded the threshold (25 in this case). Thus, the alliance confirmation module 220 provides an alliance confirmation prompt 446 to the user 102 through the AI chatbot 110 based on the response 444 of the user 102, e.g., “Thank you for sharing this with me. Thoughts like that can be hard to shake. I may have something to help you manage your feelings around this. Would you like to give it a try?” The user 102 may accept the intervention by responding with 448 to the alliance confirmation prompt 446 provided by the AI chatbot 110, e.g., “Yes, let's try.”

FIG. 4D is an exemplary graphical representation 405 of the conversational alignment score according to some embodiments herein. In the exemplary graphical representation 405, indices of messages exchanged between the user 102 and the AI chatbot 110 are plotted in a X-axis and conversational alignment scores are plotted in a Y-axis. The exemplary graphical representation 405 depicts the conversation between the user 102 and the AI chatbot 110 includes one or more misalignments when the user 102 (i) expressed lack of trust in the AI chatbot 110, (ii) expressed uncertainty about how to respond to the AI chatbot 110, and (iii) didn't understand what the AI chatbot 110 was saying or asking.

In some embodiments, the conversational alignment score is increased by the conversational alignment monitoring module 212 if at least one of the emotion is detected by the emotion detecting AI model 206, (ii) medicalized terms are detected using the medicalized term detecting AI model 208, and (iii) domain is detected using the domain detecting AI model 210. In some embodiments, the conversational alignment score is increased by the conversational alignment monitoring module 212 if the alignment detecting module 214 detects that the user 102 is agreeing with the AI chatbot 110. In some embodiments, the conversational alignment score is reduced by the conversational alignment monitoring module 212 if the misalignment detecting module 216 detects that the user 102 (i) expresses lack of trust in the AI chatbot 110, (ii) expresses uncertainty about how to respond to the AI chatbot 110, (iii) didn't understand what the AI chatbot 110 was saying or asking, (iv) disagrees with the AI chatbot 110, and (v) is unhappy or dissatisfied with the AI chatbot 110. In some embodiments, the conversational alignment score is updated after each response received from the user 102 at the AI chatbot 110 during the conversation and indicates strength of the conversational alignment formed between the AI chatbot 110 and the user 102.

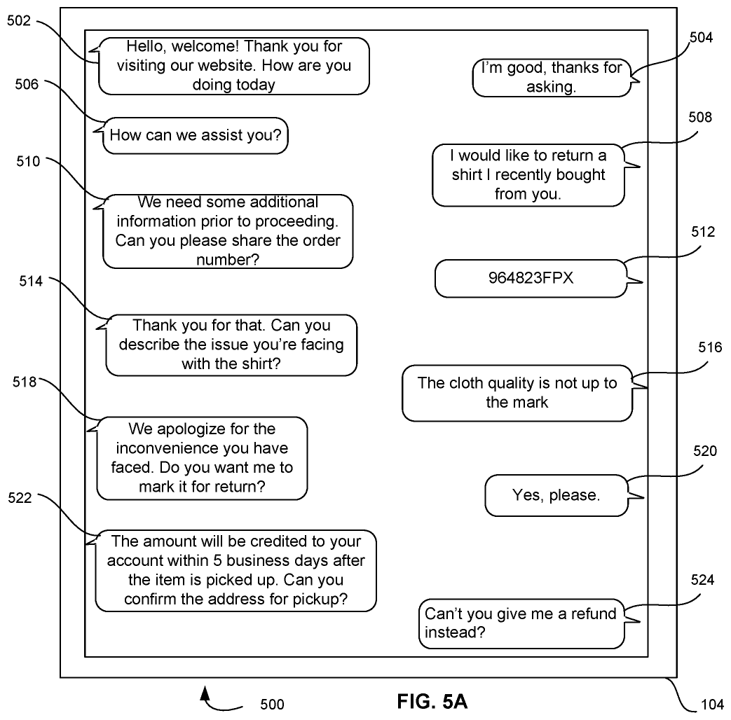

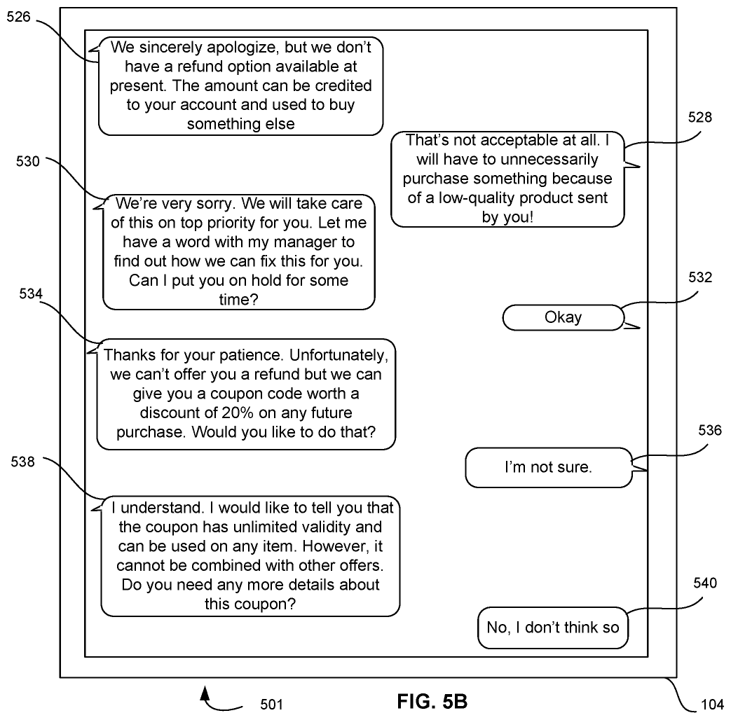

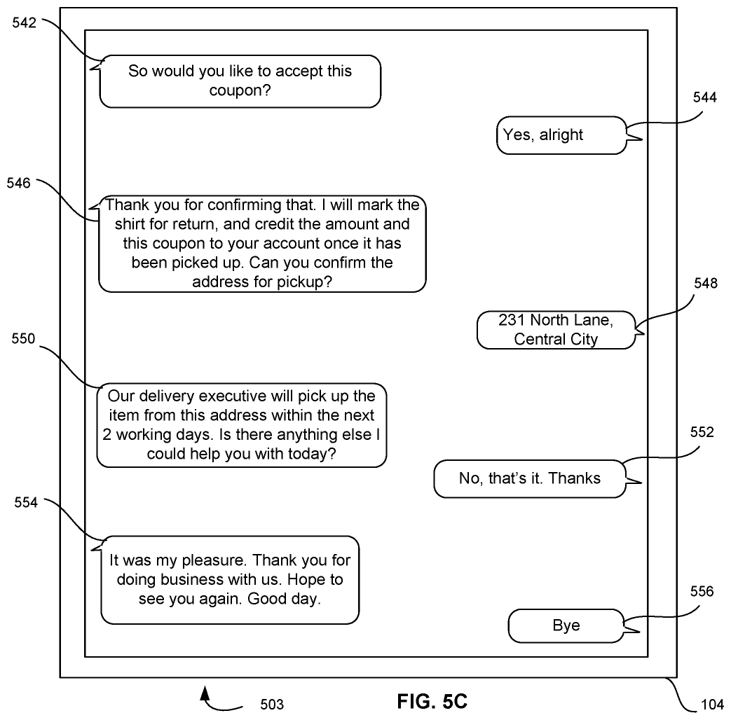

FIGS. 5A-5C are mock-up screenshots of user interfaces that illustrate a conversation between the user and the AI chatbot according to some embodiments herein. In FIG. 5A of a user interface 500, the AI chatbot 110 starts a conversation with the user 102 with a mood check 502, e.g., “Hello, welcome! Thank you for visiting our website. How are you doing today?” The user 102 may respond with 504 to the open-ended prompt 502 provided by the AI chatbot 110, e.g., “I'm good, thanks for asking.” The prompt generating module 211 provides an open-ended prompt 506 based on the sentiment detected in the user response 504 by the sentiment detection module 202 (positive in this case), e.g., “How can we assist you?” to the user 102. The user 102 may respond with 508 to the open-ended prompt 506, e.g., “I would like to return a shirt I recently bought from you.”. The conversational alignment monitoring module 212 detects that the user 102 shared some context and assigns the starting conversational alignment score as 5.

The prompt generating module 211 provides an open-ended prompt 510, e.g., “We need some additional information prior to proceeding. Can you please share the order number?” to the user 102 based on the response 508. The user 102 may respond with 512 to the open-ended prompt 510, e.g., “964823FPX”. The conversational alignment monitoring module detects that the user 102 went with the conversational flow and responded to the open-ended prompt 510 as expected. The conversational alignment monitoring module 212 increases the conversational alignment score for this user shared context to 10.

The prompt generating module 211 provides an open-ended prompt 514, e.g., “Thank you for that. Can you describe the issue you're facing with the shirt?” to the user 102 based on the response 512. The user 102 may respond with 516 to the open-ended prompt 514, e.g., “The cloth quality is not up to the mark”. The conversational alignment monitoring module detects that the user 102 shared more context when prompted. The conversational alignment monitoring module 212 increases the conversational alignment score to 15.

The prompt generating module 211 provides an empathetic open-ended prompt 518, e.g., “We apologize for the inconvenience you have faced. Do you want me to mark it for return?”, to the user 102 based on the response 516. The user 102 may respond with 520 to the open-ended prompt 518, e.g., “Yes, please.”. The conversational alignment monitoring module 212 detects that the user 102 agreed with the AI chatbot 110. The conversational alignment monitoring module 212 of the AI model 112 increases the conversational alignment score to 20.

The prompt generating module 211 provides an open-ended prompt 522, e.g., “The amount will be credited to your account within 5 business days after the item is picked up. Can you confirm the address for pickup?” to the user 102 based on the response 520. The user 102 may respond with 524 to the open-ended prompt 522, e.g., “Can't you give me a refund instead?”. The misalignment detecting module 216 detects that there is a minor misalignment in the conversation between the user 102 and the AI chatbot 110 as the user 12 didn't share the information they were requested for with the AI chatbot 110. The conversational alignment monitoring module 212 reduces the conversational alignment score to 18.

In FIG. 5B of a user interface 501, the prompt generating module 211 provides a recovery prompt 526, e.g., “We sincerely apologize, but we don't have a refund option available at present. The amount can be credited to your account and used to buy something else.” to the user 102 based on the response 524. The user 102 may respond with 528 to the recovery prompt 526, e.g., “That's not acceptable at all. I will have to unnecessarily purchase something because of a low-quality product sent by you!” The misalignment detecting module 216 detects that there is a major misalignment in the conversation between the user 102 and the AI chatbot 110 as the user 102 is unhappy with the AI chatbot 110. The conversational alignment monitoring module 212 reduces the conversational alignment score to 13.

The prompt generating module 211 provides an empathetic recovery prompt 530, e.g., “We're very sorry. We will take care of this on top priority for you. Let me have a word with my manager to find out how we can fix this for you. Can I put you on hold for some time?” to the user 102 based on the response 528 for the recovery prompt 526. The user 102 may respond 532 to the recovery prompt 530, e.g., “Okay”. The alignment detecting module 214 detects that the user 102 responded positively to the AI chatbot 110 and wants to continue the conversation. The conversational alignment monitoring module 212 rewards this recovery by increasing the conversational alignment score to 23.

The prompt generating module 211 provides a closed-ended prompt 534, e.g., “Thanks for your patience. Unfortunately, we can't offer you a refund but we can give you a coupon code worth a discount of 20% on any future purchase. Would you like to do that?” to the user 102 based on the response 532. The user 102 may respond with 536 to the open-ended prompt 534, e.g., “I'm not sure.”. The misalignment detecting module 216 detects that there is a minor misalignment in the conversation between the user 102 and the AI chatbot 110 as the user 102 expressed uncertainty about how to respond to the AI chatbot 110. The conversational alignment monitoring module 212 reduces the conversational alignment score to 21.

The prompt generating module 211 provides a closed-ended prompt 538, e.g., “I understand. I would like to tell you that the coupon has unlimited validity and can be used on any item. However, it cannot be combined with other offers. Do you need any more details about this coupon?” to the user 102 based on the response 536 for the open-ended prompt 534. The user 102 may respond with 540 to the closed-ended prompt 538, e.g., “No, I don't think so”. The alignment detecting module 214 detects that the conversation between the user 102 and the AI chatbot 110 is aligned. The conversational alignment monitoring module 212 rewards the recovery by increasing the conversational alignment score to 25.

In FIG. 5C of a user interface 503, the conversational alignment score monitoring module 212 detects that the conversational alignment score has reached the threshold (25 in this case). Hence, the alliance confirmation module 220 provides an alliance confirmation prompt 542, e.g., “So would you like to accept this coupon?” to the user 102 based on the response 540. The user 102 may respond with 544 to the closed-ended prompt 542, e.g., “Yes, alright”. The alignment detecting module 214 detects that the user 102 accepted the solution suggested by the AI chatbot 110. The AI chatbot 110 rounds up the conversation by asking the user 102 for their return pickup address through 546 and completing the transaction through 550 and 554. In some embodiments, FIGS. 5A-5C illustrate a different chatbot application which is more transactional in nature and may not require giving the user 102 a space to vent. In some embodiments, a threshold can be designed according to the chatbot application.

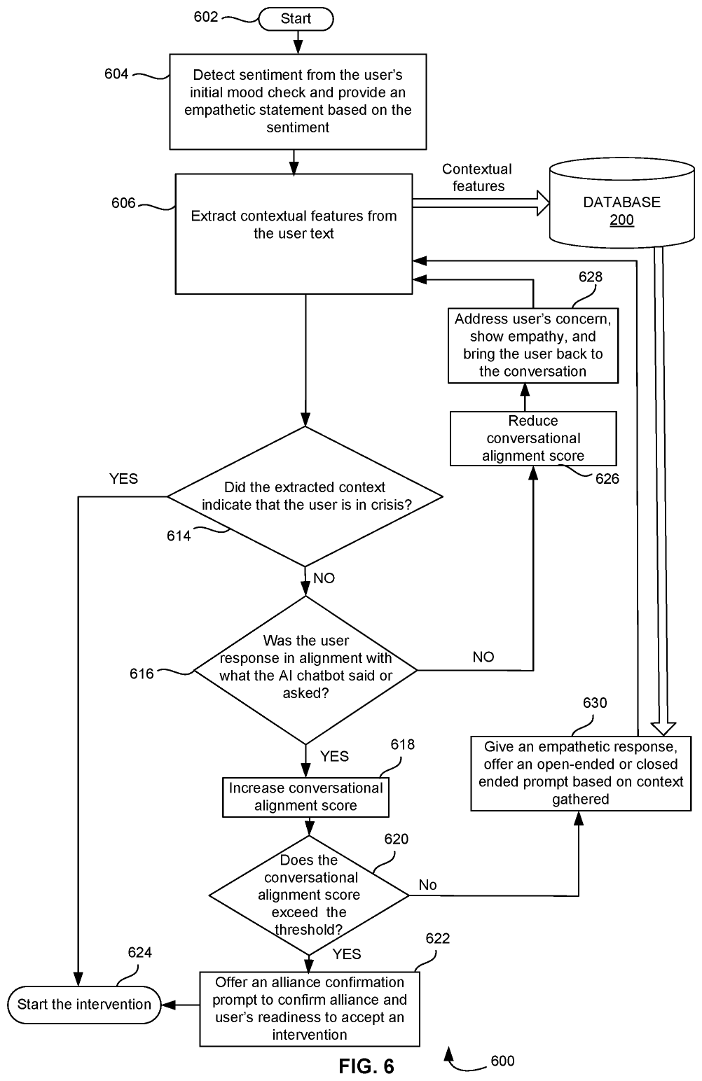

FIG. 6 is a flowchart that illustrates a method 600 for monitoring a conversational alignment and establishing an alliance between the artificial intelligence (AI) chatbot 110 and the user 102 according to some embodiments herein. At a step 602, a conversation is started with the AI chatbot 110 by the user 102. At a step 604, sentiment of the user's opening text is detected and an empathetic statement is provided to the user 102 based on the sentiment by the AI model 112. At a step 606, one or more contextual features are extracted by the AI model 112. In some embodiments, the one or more contextual features are stored in the database 200 of the server 108. At the step 614, it is checked if the extracted features indicate that the user 102 is in crisis. If YES, control goes to step 624 or else goes to step 616. At the step 616, it is checked if the user 102 responded in alignment with what the AI chatbot 110 said or asked. If Yes, control goes to step 618 or the conversational alignment score is reduced at step 626 and the user's concern is addressed, empathy is shown, and brings the user 102 back to the conversation at step 628. At the step 618, the conversational alignment score is increased if the user 102 responded in alignment with what the AI chatbot 110 said or asked. At the step 620, it is checked if the conversational alignment score exceeds a threshold, if YES, control goes to step 622 or else goes to step 630. At step 622, an alliance confirmation prompt is provided to the user 102 by the server 108 through the AI chatbot 110 to confirm alliance and user's readiness to accept an intervention. At a step 624, an intervention is started. At a step 630, an empathetic response, an open-ended or closed-ended prompt based on context gathered.

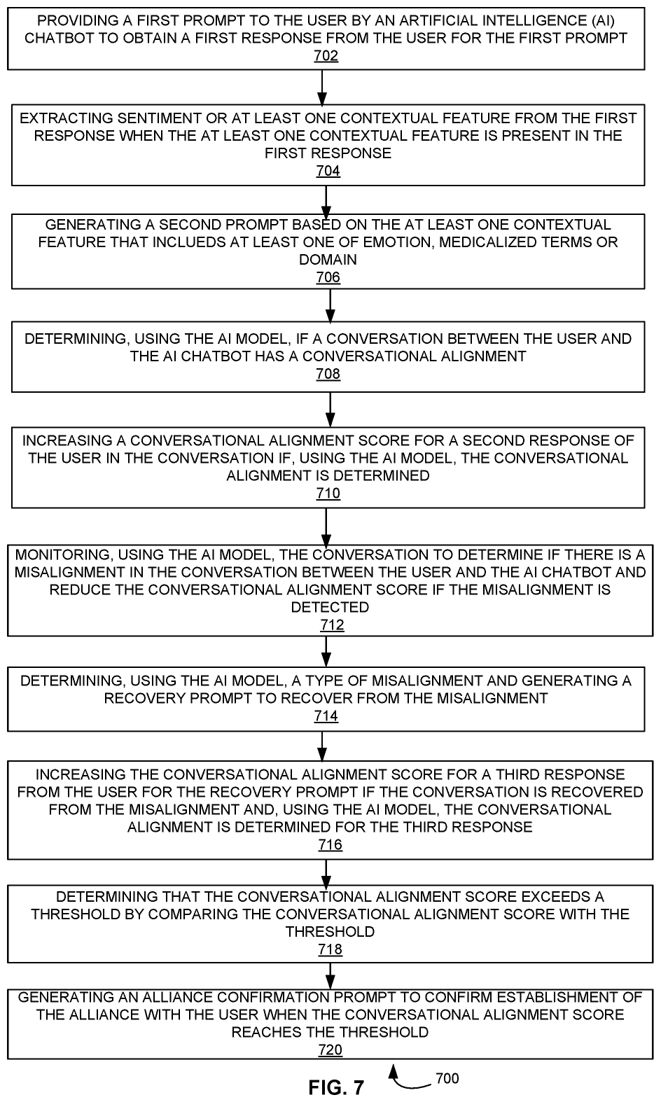

FIG. 7 is a flow diagram that illustrates a method 700 for monitoring and improving conversational alignment to develop an alliance between the artificial intelligence (AI) chatbot 110 and the user 102 according to some embodiments herein. At a step 702, the method 700 includes providing a first prompt to the user 102 by the AI chatbot 110 to obtain a first response from the user 102 for the first prompt. The first response is at least one of a text input or a voice input. At a step 704, the method 700 includes extracting sentiment or at least one contextual feature from the first response when the at least one contextual feature is present in the first response. Extracting the at least one contextual feature includes detecting that the first response of the user 102 includes at least one of emotion, medicalized terms or domain. The emotion is detected using the emotion detecting artificial intelligence (AI) model 206, the medicalized terms are detected using the medicalized term detecting AI model 208, and the domain is detected using the domain detecting AI model 210.

At a step 706, the method 700 includes generating a second prompt based on the at least one contextual feature that includes at least one of the emotion, the medicalized terms or the domain. At a step 708, the method 700 includes determining, using the AI model 112, if a conversation between the user 102 and the AI chatbot 110 has a conversational alignment. The conversational alignment is an alignment with respect to the user sharing more context with the AI chatbot 110 and agreeing to suggestions or interpretations made by the AI chatbot 110. At a step 710, the method 700 includes increasing a conversational alignment score for a second response of the user 102 in the conversation if, using the AI model 112, the conversational alignment is determined. At a step 712, the method 700 includes monitoring, using the AI model 112, the conversation to determine if there is a misalignment in the conversation between the user 102 and the AI chatbot 110 and reduce the conversational alignment score if the misalignment is detected. At a step 714, the method 700 includes determining, using the AI model 112, a type of misalignment and generating a recovery prompt to recover from the misalignment. At a step 716, the method 700 includes increasing the conversational alignment score for a third response from the user 102 for the recovery prompt if the conversation is recovered from the misalignment and, using the AI model 112, the conversational alignment is determined for the third response. At a step 718, the method 700 includes determining that the conversational alignment score exceeds a threshold by comparing the conversational alignment score with the threshold. At a step 720, the method 700 includes generating an alliance confirmation prompt to confirm establishment of the alliance with the user 102 when the conversational alignment score reaches the threshold.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps. The embodiments herein can include both hardware and software elements. The embodiments that are implemented in software include but are not limited to, firmware, resident software, microcode, etc. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

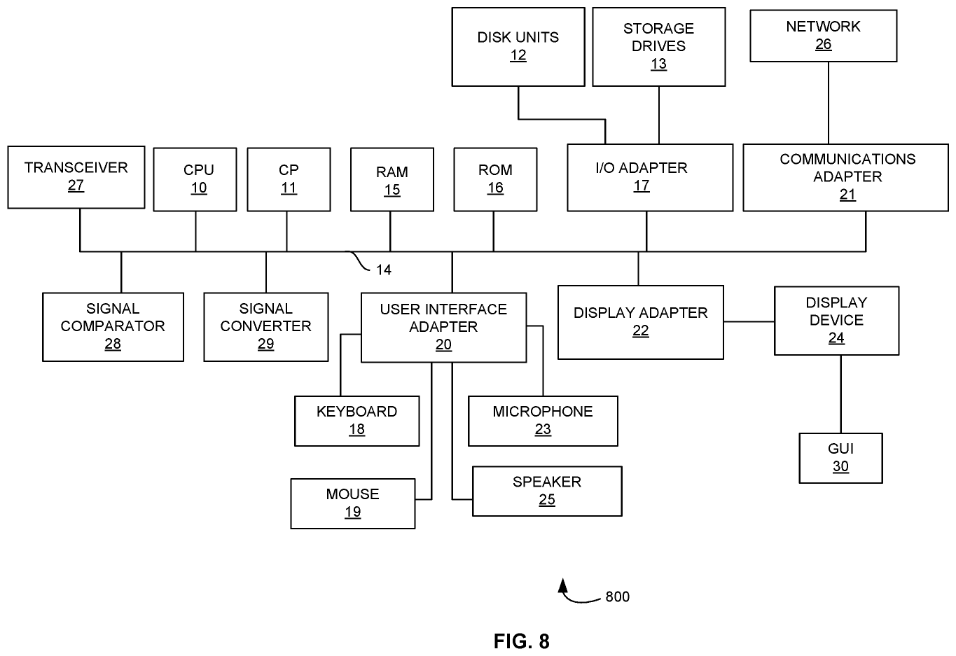

A representative hardware environment for practicing the embodiments herein is depicted in FIG. 8, with reference to FIGS. 1 through 7. This schematic drawing illustrates a hardware configuration of the AI model 112/a computer system/a user device 104 in accordance with the embodiments herein. The user device 104 includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The user device 104 can read the inventive instructions on the program storage devices and follow these instructions to execute the methodology of the embodiments herein. The user device 104 further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A processor-implemented method for monitoring and improving conversational alignment to develop an alliance between an artificial intelligence (AI) chatbot and a user, comprising:
dynamically generating, using an artificial intelligence (AI) model at the server, a first prompt based on context gathered from a user device associated with the user;
automatically providing, using the AI model at the server, the first prompt to the user by the AI chatbot to obtain a first response from the user device associated with the user for the first prompt, wherein the first response is at least one of text or voice;
training the AI model at the server by vectorizing the text received from the user to convert the text into a numerical representation to use the numerical representation corresponding to the text;
extracting, using the AI model at the server, sentiment or at least one contextual feature from the first response when the at least one contextual feature is present in the first response by detecting that the first response of the user comprises at least one of emotion using an emotion detecting artificial intelligence (AI) model, medicalized terms using a medicalized term detecting AI model or domain using a domain detecting AI model;
generating, using the AI model at the server, a second prompt based on the at least one contextual feature that comprises at least one of the emotion, the medicalized terms, or the domain;
determining, using the AI model at the server, if a conversation between the user and the AI chatbot has a conversational alignment to increase a conversational alignment score for a second response of the user in the conversation if the conversational alignment is determined, wherein the conversational alignment is an alignment with respect to the user sharing more context with the AI chatbot and agreeing to suggestions or interpretations made by the AI chatbot;
continuously monitoring, using the AI model at the server, the conversation to determine if there is a misalignment in the conversation between the user and the AI chatbot and reduce the conversational alignment score if the misalignment is detected;
training a plurality of machine learning models based on training data that comprises user text that is labeled as true, and the user text labeled as false, an intent for each type of misalignment for intent recognition by providing representative patterns for each type of misalignment;
classifying, using the plurality of machine learning models at the server, a type of misalignment from a plurality of misalignments;
generating a recovery prompt to recover from the misalignment based on the type of misalignment that is classified by the plurality of machine learning models at the server;
increasing, using the AI model at the server, the conversational alignment score for a third response from the user for the recovery prompt if the AI model at the server determines that there is conversational alignment for the third response;
determining, using the AI model at the server, that the conversational alignment score exceeds a threshold by comparing the conversational alignment score with the threshold; and
generating, using the AI model at the server, an alliance confirmation prompt to confirm establishment of the alliance with the user when the conversational alignment score reaches the threshold.

2. The method of claim 1, further comprising if a plurality of contextual features are detected in each response of the user, prioritizing the plurality of contextual features to decide which direction to take the conversation, wherein the plurality of contextual features are prioritized as (i) the at least one medicalized term, (ii) domain, and (iii) emotion.

3. The method of claim 1, wherein prompts are generated based on a contextual feature that has highest priority among the plurality of contextual features, wherein the contextual feature that has the highest priority is identified by prioritizing the plurality of contextual features in a decreasing order.

4. The method of claim 1, wherein the type of misalignment is selected from at least one of confusion, disagreement, dissatisfaction, lack of trust, refusal or uncertainty expressed by the user to the AI chatbot.

5. The method of claim 4, wherein at least one of the confusion, the disagreement, the dissatisfaction, the lack of trust, the refusal or uncertainty expressed by the user to the AI chatbot is detected using the intent recognition AI model.

6. (canceled)

7. (canceled)

8. The method of claim 5, wherein if a confidence score for the matching pattern with a highest confidence score is above an intent matching threshold, a response received from the user is determined to correspond to the intent that the matching pattern represents.

9. (canceled)

10. The method of claim 1, wherein the conversational alignment score is updated after each response received from the user at the AI chatbot during the conversation and indicates strength of the conversational alignment formed between the AI chatbot and the user.

11. The method of claim 1, wherein the text input is vectorized using frequency-based techniques or semantics-based techniques.

12. The method of claim 1, wherein the prompts are generated based on predefined base prompts that are written by conversation designers and parameterized with the user's context to personalize them, wherein the predefined base prompts are stored in a database of a server.

13. The method of claim 1, wherein the prompts are provided to the user through the AI chatbot until the conversational alignment score exceeds the threshold.

14. The method of claim 1, wherein at least one of the open-ended prompts or the closed-ended prompts are alternately provided to the user based on the conversational alignment score.

15. The method of claim 1, further comprising recommending at least one intervention to the user when the alliance has been confirmed using the alliance confirmation prompt in which the user agrees to try out an intervention.

16. One or more non-transitory computer readable storage mediums storing one or more sequences of instructions, which when executed by one or more processors, causes a method for monitoring and improving conversational alignment to develop an alliance between an artificial intelligence (AI) chatbot and a user by performing the steps of:
dynamically generating, using an artificial intelligence (AI) model at the server, a first prompt based on context gathered from a user device associated with the user;
automatically providing, using the AI model at the server, the first prompt to the user by the AI chatbot to obtain a first response from the user device associated with the user for the first prompt, wherein the first response is at least one of text or voice;
training the AI model at the server by vectorizing the text received from the user to convert the text into a numerical representation to use the numerical representation corresponding to the text;
extracting, using the AI model at the server, sentiment or at least one contextual feature from the first response when the at least one contextual feature is present in the first response-by detecting that the first response of the user comprises at least one of emotion using an emotion detecting artificial intelligence (AI) model, medicalized terms using a medicalized term detecting AI model or domain using a domain detecting AI model;
generating, using the AI model at the server, a second prompt based on the at least one contextual feature that comprises at least one of the emotion, the medicalized terms, or the domain;
determining, using the AI model at the server, if a conversation between the user and the AI chatbot has a conversational alignment to increase a conversational alignment score for a second response of the user in the conversation if the conversational alignment is determined, wherein the conversational alignment is an alignment with respect to the user sharing more context with the AI chatbot and agreeing to suggestions or interpretations made by the AI chatbot;
continuously monitoring, using the AI model at the server, the conversation to determine if there is a misalignment in the conversation between the user and the AI chatbot and reduce the conversational alignment score if the misalignment is detected;
training a plurality of machine learning models based on training data that comprises user text that is labeled as true, and the user text labeled as false, an intent for each type of misalignment for intent recognition by providing representative patterns for each type of misalignment;
classifying, using the plurality of machine learning models at the server, a type of misalignment from a plurality of misalignments;
generating a recovery prompt to recover from the misalignment based on the type of misalignment that is classified by the plurality of machine learning models at the server;
increasing, using the AI model at the server, the conversational alignment score for a third response from the user for the recovery prompt if the AI model at the server determines that there is conversational alignment for the third response;
determining, using the AI model at the server, that the conversational alignment score exceeds a threshold by comparing the conversational alignment score with the threshold; and
generating, using the AI model at the server, an alliance confirmation prompt to confirm establishment of the alliance with the user when the conversational alignment score reaches the threshold.

17. The one or more non-transitory computer readable storage mediums storing the one or more sequences of instructions of claim 16, further comprising if a plurality of contextual features are detected in each response of the user, prioritizing the plurality of contextual features to decide which direction to take the conversation, wherein the plurality of contextual features are prioritized as (i) the at least one medicalized term, (ii) domain, and (iii) emotion.

18. The one or more non-transitory computer readable storage mediums storing the one or more sequences of instructions of claim 16, wherein prompts are generated based on a contextual feature that has highest priority among the plurality of contextual features, wherein the contextual feature that has the highest priority is identified by prioritizing the plurality of contextual features in a decreasing order.

19. (canceled)

20. A system for monitoring and improving conversational alignment to develop an alliance between an artificial intelligence (AI) chatbot and a user comprising:
a device processor; and
a non-transitory computer readable storage medium storing one or more sequences of instructions, which when executed by the device processor, causes a method by performing the steps of:
dynamically generating, using an artificial intelligence (AI) model at the server, a first prompt based on context gathered from a user device associated with the user;
automatically providing, using the AI model at the server, the first prompt to the user by the AI chatbot to obtain a first response from the user device associated with the user for the first prompt, wherein the first response is at least one of text or voice;
training the AI model at the server by vectorizing the text received from the user to convert the text into a numerical representation to use the numerical representation corresponding to the text;
extracting, using the AI model at the server, sentiment or at least one contextual feature from the first response when the at least one contextual feature is present in the first response-by detecting that the first response of the user comprises at least one of emotion using an emotion detecting artificial intelligence (AI) model, medicalized terms using a medicalized term detecting AI model or domain using a domain detecting AI model;
generating, using the AI model at the server, a second prompt based on the at least one contextual feature that comprises at least one of the emotion, the medicalized terms, or the domain;
determining, using the AI model at the server, if a conversation between the user and the AI chatbot has a conversational alignment to increase a conversational alignment score for a second response of the user in the conversation if the conversational alignment is determined, wherein the conversational alignment is an alignment with respect to the user sharing more context with the AI chatbot and agreeing to suggestions or interpretations made by the AI chatbot;
continuously monitoring, using the AI model at the server, the conversation to determine if there is a misalignment in the conversation between the user and the AI chatbot and reduce the conversational alignment score if the misalignment is detected;
training a plurality of machine learning models based on training data that comprises user text that is labeled as true, and the user text labeled as false, an intent for each type of misalignment for intent recognition by providing representative patterns for each type of misalignment;
classifying, using the plurality of machine learning models at the server, a type of misalignment from a plurality of misalignments;
generating a recovery prompt to recover from the misalignment based on the type of misalignment that is classified by the plurality of machine learning models at the server;
increasing, using the AI model at the server, the conversational alignment score for a third response from the user for the recovery prompt if the AI model at the server determines that there is conversational alignment for the third response;
determining, using the AI model at the server, that the conversational alignment score exceeds a threshold by comparing the conversational alignment score with the threshold; and
generating, using the AI model at the server, an alliance confirmation prompt to confirm establishment of the alliance with the user when the conversational alignment score reaches the threshold.
